(19) United States
(12) Patent Application Publication
(10) Pub. No.: US 2007/0192293 A1
(43) Pub. Date: Aug. 16, 2007

(54) Method for presenting search results

(76) Inventor: Bing Swen, Beijing (CN)

Correspondence Address: Dr. Bolesh J. Skutnik;BJ Associates, 51 Banbury Lane, West Hartford, CT, 06107, US

(21) Appl. No.: 11/352,731

(22) Filed: Feb. 13, 2006

(51) Int. Cl. G06F 17/30

(52) U.S. Cl. 707/3

(57) ABSTRACT

Methods and systems are provided to present the search results in response to a search query that is submitted to a document retrieval system, such as a search engine. The search results are presented with a second-retrieval model that constructs multiple derived queries for the search query with a first small-document retrieval process, and then generates and outputs the results based on the retrieval of search results of at least part of the derived queries. One embodiment of the invention provides a method for grouping the search results, which presents ranked derived queries together with their search results to the user, in such a way that derived queries with higher ranks and top-ranked documents of each derived query are preferentially presented, and the grouped results are displayed and navigated in independent framed subareas of an output window. A further embodiment selects the search results from multiple result lists of the derived queries to form the final search results for the user query, wherein the merged results are re-ranked according to pre-determined criteria. The method can also be integrated with the local keyword associated clustering method by rank value adjustment, or result filtering or merging to achieve better technical effects.

### BACKGROUND OF THE INVENTION

1. Field of the Invention

The present invention relates generally to techniques for information retrieval, and more particularly, to methods and systems for generating and presenting search results based on the query submitted by a user using a computer or computer network, for example, a method for presenting the search results in an online document retrieval system or an Internet search engine.

2. Description of Related Art

Present-day document retrieval systems based on computer or computer network typically return the search results in response to a user's search request in a ranked list of document representations (e.g., titles, abstracts and hyperlinks), ordered by their estimated relevance to the query included in the search request. Users are supposed to sift through this linear list and select documents that are actually relevant or interesting. For very large document collections such as the web page (HTML or XML document) collections of Internet search engines, the returned search result lists typically consist of a large number of documents, the vast majority of which are of no interest to the users. It would be very difficult and a great burden for the users to find information from a list of hundreds or thousands of candidate documents. On the other hand, search users have been accustomed to submitting short queries of very few keywords that may be of broad use and ambiguous. For the current mainstream search engines that are keyword based document indexing and retrieval systems (e.g., www.Google.com, search.Yahoo.com, search.MSN.com, www.Baidu.com, etc.), the search results of queries comprising ambiguous or broadly used keywords (such as “notebook”, “virus”, “mp3”, etc.) are often heterogeneous in topics, genres and quality, which makes additional difficulties for the users to efficiently find interested information. Although the problem of short, ambiguous or over-general search queries has been partially addressed with search improvement suggestion techniques, such as related, similar or suggested searches that are in use by some search engines (which are usually queries submitted by other users in the search log), such related or suggested search queries are not utilized to generate or improve the search results presented to the user.

In document retrieval and Internet search, much effort has been put into the improvement of search result quality and user browsing efficiency. In one aspect, more document information has been utilized to improve the precision of document ranking (e.g., making full use of the hyperlink characteristics of web pages, quality and update information of web sites, the format information of text, etc.) so as to put as many as possible documents that the users may be most interested in to the front positions in the output search result list. In another aspect, methods to automatically group search results have been developed to improve the efficiency and convenience of result browsing. Ideally, a document retrieval system such as a search engine will group the search results into subsets of similar or related documents, so that the user can narrow down the lookup scope within a few interested groups and find the desired information more easily and efficiently.

Techniques for grouping search results can be categorized into two classes: one is document classification, or more precisely called document categorization, which groups documents into subsets according to their predetermined categories (determined prior to processing any search request); the other is called document clustering, or usually called search result clustering, which groups the documents with similar features in a search result list into subsets (called document clusters) that are generated and named dynamically (i.e., they may vary with each query and its search results). Document classification has the advantage of runtime efficiency (as the categories of each document in the document collection have been predetermined), but the disadvantages of low quality and maintenance cost, especially for dynamic and highly heterogeneous document collections such as web page collections (as predetermining the categories of each document is typically difficult, costly, of low precision, and a static whole-collection grouping has to be constantly updated and thus in general inappropriate in such contexts). Search result clustering has much less maintenance cost and can reflect the dynamic nature of search queries and their results, but has the severe disadvantage of runtime efficiency, since the grouping process must be performed online (on-the-fly), and most quality clustering algorithms have the time complexity O(N²)˜O(N³), where N is the number of documents to be clustered, which would be generally unaffordable for any medium or large scale document retrieval systems.

At present, search result clustering is actively investigated in the development of online (on-the-fly) clustering of metasearch engines. A metasearch engine does not index web documents but, in response to a user's query, queries other (independent, general-purpose) search engines and then combines the returned search results to construct its own search result list for the user's query. The combination process provides an opportunity to apply some lightweight online clustering on the short result descriptions (usually called web-snippets) returned by the queried search engines. Currently the best-known web-snippet clustering engine is Vivisimo.com (and its commercialized version Clusty.com). Web-snippet clustering engines reorganize the metasearch results into a hierarchy of clusters that are named by the common substrings (words or phrases) included in the clustered documents, allowing users to navigate through the hierarchy to refine the search. To meet the strict time requirements of online user interaction, all the known metasearch clustering methods have to impose strong limits on the number of document snippets (typically within 200, with response latency in ˜5 seconds). Additionally, metasearch engine based search result clustering has certain shortcomings. As one may easily verify by experiments, this kind of clustering is typically very slow, small-scale and of low quality. The web-snippets returned from other search engines, as input of the clustering, are highly unpredictable and far from accurate representations of the original web pages, leading to uncontrollable (often very poor) clustering effects. The tree-like organization of clusters commonly used by metasearch clustering engines also makes additional burden of cluster name understanding, document snippet lookup and significantly more hyperlink clicks to locate information.

In the U.S. patent application Ser. No. 11/263,820 (also the China patent application Serial No. 200410091772.7 and Publication No. CN1609859A, in the name of SWEN Bing, entitled “METHOD FOR SEARCH RESULT CLUSTERING”), a search result clustering method to address the runtime efficiency problem is presented, which employs a “keyword associated clustering” (KWAC for short) technique to realize efficient large-scale search result clustering that dose not limit the number and content of documents and the number of generated clusters. The technique predetermines and records the classes of each document with respect to its index keywords, such that the clustering classes that are local up to a single document and a query term can be efficiently determined via the keywords included in the search query. This will effectively turn an unsupervised clustering problem into a categorization problem that can be efficiently performed, and avoid the shortcomings of conventional categorization that must assign a static, global class (or class set) to each document, where the document classes are independent to search queries. Although the method can be efficient and effective for most short queries, for complex search queries (e.g., queries with multiple keywords and condition combinations formed via the “advanced search” mode of search engines), its processing to determining the various meanings of such queries based on multiple local clustering classes will be complex and thus inaccurate, or require the support of a lot of language data resources. Also, the clustered results may have deficiencies in completeness and understandability.

Thus, there remains a need to improve the quality of the methods and systems for grouping and ranking search results.

### OBJECTIVES AND SUMMARY OF THE INVENTION

It is an objective of the present invention to provide techniques to obtain various derived forms of a user's search query to construct the final search results, and to present the search results in a classified way with the derived queries.

It is another objective of the invention to provide techniques to rank the derived queries.

It is a third objective of the invention to provide techniques to combine the search results generated by multiple derived queries with the search result clustering method as set forth in U.S. patent application Ser. No. 11/263,820 (also the China patent application Serial No. 200410091772.7 and Publication No. CN1609859A) to achieve better technical effects.

The invention provides methods and systems to construct a set of derived queries for a user's search query. The final search results of the user's search query are generated based on the derived queries. Derived queries are used to provide an efficient, large-scale and high quality classification of the result documents when searched with said search query, as well as to provide improved ranking of the relevant documents in the final search results.

One embodiment of the present invention provides a method for grouping the search results, which includes constructing multiple derived queries for a user's search query. This method further includes obtaining the search results of each of the derived queries with higher ranks, and then returning these derived queries, together with the results with higher document ranks in the search result list of each of the returned derived queries, to the user.

A further embodiment of the present invention provides a method for selecting search results from multiple search result lists, which includes constructing multiple derived queries for a user's search query. This method further includes obtaining the search results of each of the derived queries with higher ranks, and then combining these derived queries' search results to form the final search results of the user's search query.

Each of said derived queries can be associated with a rank value according to its similarity to the user's search query, its frequency of search, the number and ranks of the documents in its corresponding search results, etc. Derived queries are ordered by their ranks, and derived queries with higher ranks can be preferentially presented to the user. All of the derived queries of a search query can be efficiently obtained using the indexing and retrieval of a small-unit index. Each derived query and its search results can be displayed and navigated in an independent framed subarea of the output window. To get better technical effects for complex search queries, the global derived queries and the clustering classes that are local to individual documents can be combined by adjusting the ranks of derived queries or clustering classes, merging or filtering of the search results.

Additional aspects and advantages will become apparent in view of the following detailed description and associated figures.

### BRIEF DESCRIPTION OF THE DRAWINGS

The five accompanying drawings illustrate the underlying technical scheme and two embodiments of the invention.

FIG. 1 is a flowchart of exemplary processing for presenting search results based on derived queries consistent with the principles of the invention.

FIG. 2 is a flowchart of exemplary processing for presenting search results in a classified way according to an embodiment of the invention.

FIG. 3 is a flowchart of exemplary processing for presenting search results by combining the search results of derived queries according to an embodiment of the invention.

FIG. 4 is a screen shot illustrating exemplary screen display of the top-ranking derived queries and their individual search results with highest document ranks for the search query “virus” according to an embodiment of the invention.

FIG. 5 is a screen shot illustrating exemplary screen display of the top-ranking search results by combining the search results of derived queries for the search query “virus” according to an embodiment of the invention.

### DETAILED DESCRIPTION OF THE INVENTION

Methods and systems consistent with the principles of the invention can be implemented within conventional document retrieval system architectures, such as an Internet search engine. As would be known by anyone of ordinary skill in the art, a search engine system consists of three major components, namely a crawling component for discovering and collecting web documents (HTML and other data format documents), an indexing component for building an index of the crawled web document collection, and a retrieval (or search) component that in response to a search query, identifies via the index a subset of documents as the search results that are relevant (by some ranking criteria) to the search query. As a large-scale document retrieval system, a search engine typically uses inverted indexes, i.e., indexes that record for each keyword (called an index keyword or a term) a list of documents that contain that keyword. Such a list is usually termed an inverted list. An inverted index consists of many inverted lists, each of which corresponds to an index keyword. In many cases, the inverted index may include more information on the frequency, occurrence positions and text formats of each keyword in each document. A document may contain many keywords, and hence may be included by many inverted lists. In the field of information retrieval, the term “keyword” is referred to as a text unit for indexing and searching, which should be interpreted broadly to include a word, a phrase of words, or any other kind of character strings (for example, a bigram), as the term is used herein.

Assuming a collection of documents {dᵢ|i=1, 2, . . . , N}, where N is the total number of documents. A search engine indexes these documents with a set of keywords {kwⱼ|j=1, 2, . . . , K}. The process of document retrieval is the search of the index using the keywords included in a query, which consists of a single keyword or a logic expression of several keywords. Let Query include the keywords kw₁, kw₂, . . . , kwₓ, denoted by an expression Q(kw₁, kw₂, . . . , kwₓ). The set of all the documents containing a search keyword kwᵢ can be directly retrieved via the inverted list of kwᵢ in the index. The set of documents relevant to Query may be efficiently constructed with the documents in the inverted lists of keywords kw₁, kw₂, kwₓ (with proper set operations such as union, intersection, etc.). The system may then rank the relevant documents using some criteria (such as word frequency, order, position or text format, or cross references between documents) and assigns a score to each document as a measure of the estimated relevance degree to the query. The final list of search results is constructed by selecting a certain number (e.g., 1000) of top ranked relevant documents and sorting them reversely by their relevance scores. After generating a representation (typically including a title, a keyword-in-context abstract, and a hyperlink) for each of the result documents, the search result list may be properly organized with a display page and sent to the computer at the user's end.

For interactive information retrieval systems such as search engines, the search queries submitted by the users are usually very short, comprising only a few keywords, and thus often include many possible search purposes. For example, the query Q=“virus” is a highly ambiguous search query, with which different users may express very different meanings: the search for biologic viruses (e.g., hepatitis viruses, AIDS viruses, etc.), or search for a computer virus (software). For each of the possible meanings, there may be various kinds of usage, e.g., in the case of computer viruses, the user's search topic may be one of the following possibilities: virus prevention, download of virus cleaning software, virus library updating, elements of computer viruses, etc.

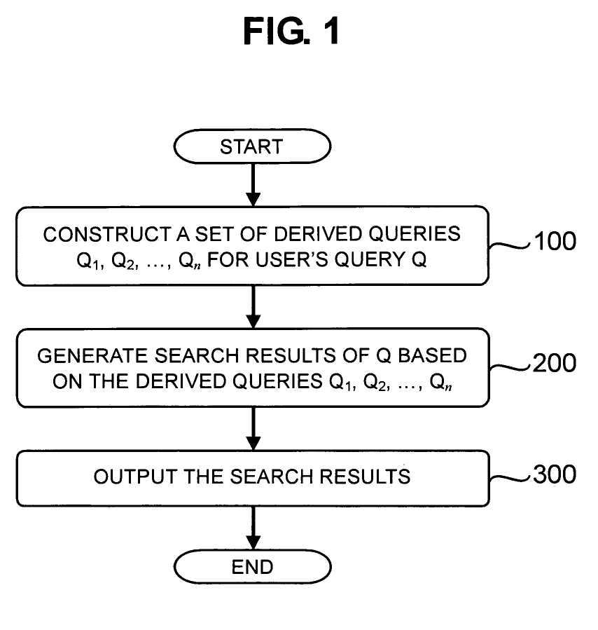

To better deal with such situations, the search result presenting method of the present invention employs a “second retrieval model” of document retrieval. FIG. 1 is a flowchart of exemplary processing of the second retrieval model, comprising the following steps:
first, at act 100, it constructs a set of derived queries Q₁, Q₂, . . . , and Qₙ for the user's search query Q, which can be implemented via a (first) retrieval mechanism (see below for details);
it then obtains the search results of each of the derived queries Q_{1, . . . , n} via a conventional (the second) retrieval model, and the final search results of the user's search query Q are generated by grouping, reorganizing, combining or re-ranking the search result lists of the derived queries (act 200);
the final search results are then output to the search user's computer after a representation is generated for the result documents (act 300).

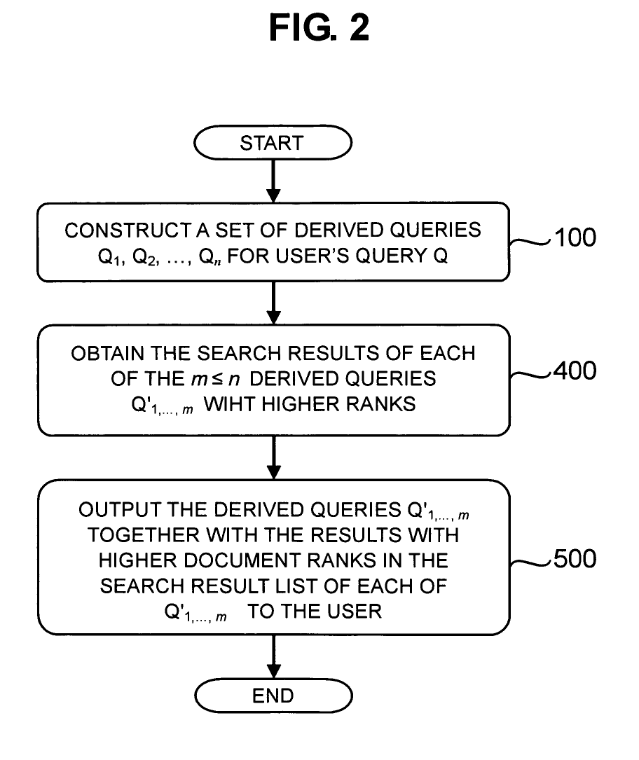

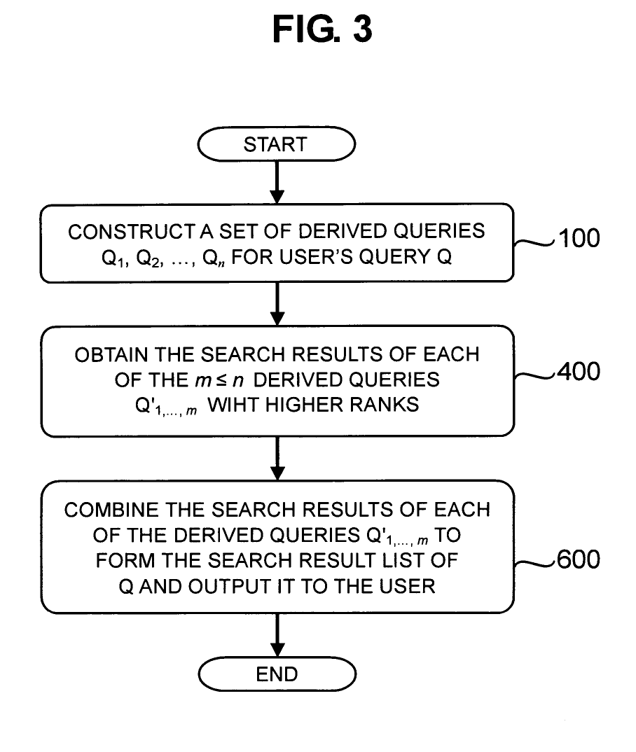

The above model can be implemented in various ways in a conventional search engine system. Two preferential embodiments consistent with the principles of the invention are further described in FIG. 2 and FIG. 3 respectively.

The embodiment of FIG. 2 provides a method for grouping the search results using multiple derived queries Q₁, Q₂, . . . , Qₙ constructed for a user's search query Q (act 100). This method further includes obtaining the search results of each of the m≦n derived queries Q′₁, Q′₂, . . . , Q′ₘ with higher ranks (act 400), and then returning these derived queries Q′_{1, . . . , m}, together with the top L results with higher document ranks in the search result list of each of the returned derived queries Q′_{1, . . . ,m}, to the user (act 500).

The embodiment of FIG. 3 provides a method for selecting search results from multiple search result lists of the derived queries Q₁, Q₂, . . . , Qₙ constructed for a user's search query Q (act 100). It further includes obtaining the search results of each of the m≦n derived queries Q′₁, Q′₂, . . . , Q′ₘ with higher ranks (act 400), and then combining the search result lists of the derived queries Q′_{1, . . . m} to form the final search results of the search query Q, which is then output to the user (act 600).

The underlying technical scheme of the invention has been fully specified by the exemplary processing and the embodiments of FIGS. 1, 2 and 3. More related aspects and details are presented in the following sections.

Obtaining the Derived Queries

The derived queries of the invention denote a set of queries that are closely related to a search query submitted by the user. Each of the derived queries represents a more specific meaning, or a more concrete form of usage, or a derived or auxiliary semantic, or a collocation with other associated words of the user's query. For example, some of the commonly used derived queries of the query Q=“virus” may include:

| Qᵢ, i = 1, 2, . . . | QueryRank(Qᵢ\|Q) |
|---|---|
| computer virus | 10.8% |
| virus killing software | 8.1% |
| network virus | 4.2% |
| Trojan horse virus | 2.2% |
| online virus scan | 1.4% |
| virus library update | 1.1% |
| biologic virus | 0.8% |
| virus hepatitis | 0.6% |
| AIDS | 0.5% |
| . . . | . . . |

where each derived query Qᵢ is associated with a rank QueryRank(Qᵢ|Q) according to factors such as its similarity to the original search query Q=“virus”, the frequency of search by users, etc., which is listed after the derived query (representable by a percentage).

To obtain the derived queries of various possible search queries, according to an embodiment consistent with the principles of the invention, a query set consisting of a large number of candidate queries, called a candidate query set, is pre-constructed, wherein each of the queries may be used as a derived query of some search query. Such query sets can be constructed by extracting candidate queries from multiple sources. In one particular embodiment, the candidate query set is constructed by comprehensively utilizing semantic dictionaries, collocation libraries, phrase rules, and corpus statistics, the method comprising:
Adding all the index terms (namely entries of the index lexicon) of current document collection to the candidate query set, and whenever updating the index lexicon, new index terms are also added to the candidate query set;
With a semantic dictionary, various synonyms, or words and phrases with the same or similar meanings or usage, can be obtained for each of the queries already included in the candidate query set, which are all added to the candidate query set;
According to the phrase and collocation relations, various phrases and collocations and their derivation forms of a candidate query are added to the candidate query set;
By the statistics of word frequencies, multi-word co-occurrences and phrase structures in large scale text corpora, more query words or phrases that are not included by the above processes can be obtained and added to the candidate query set;
Additional candidate queries can be supplemented from the user search request message logs of a search engine;
Repeating the above processing to update the candidate query set, until there are no qualified candidate queries that can be added, or the candidate query set has reached a given scale (e.g. 5 million), such that the constructed candidate query set sufficiently covers most of the closely related forms of each of its elements.

Thus, the process to obtain the derived queries of any search query becomes the process to find out its closely related candidate queries from the candidate query set, corresponding to various synonyms, semantic equivalents, ambiguous forms and collocations. There are multiple algorithms for character string searches that can be used to implement such a lookup process. Since the number of query strings in the candidate query set may be very large (typically around several millions), for the reason of efficiency, a special string retrieval method using small index units can be employed. According to an embodiment of the invention, the method comprises the following steps:
Indexing each of the queries in the candidate query set as a small document with an index lexicon including only small index units;
Building an inverted index for the whole candidate query set;
Processing the user's search query as a small document the same way as the candidate queries, and via the inverted index of the candidate query set, selecting the candidate queries with a certain similarity with the search query.

The retrieval method actually used for selecting similar candidate queries can be one of any retrieval models well known in the field, such as the Boolean model, or the Vector Space Model (VSM), or a Probabilistic Model (e.g., the Language Model). The particular point in this method is the use of small (fine-grained) index units for the indexing of the candidate query set. In one particular embodiment, a special-purpose index lexicon is constructed, whose entries are short terms of very few keywords (only one or two words) that are stably used, of high frequency in corpora, and occurring frequently in longer phrases. Each query in the candidate query set is decomposed into a document vector in the space of the small index units via such fine-grained index lexicon.

Further, to perform the retrieval of synonymy and equivalent use, according to an embodiment consistent with the principles of the invention, the document vectors corresponding to candidate queries can be transformed into a set of semantic index units, which comprises the semantic classification tags of the entries of the above fine-grained index lexicon. With such transformation, the index terms are changed to the semantic classification tags, and the inverted index may be accordingly built with these tags. Such retrieval method belongs to a semantic-based VSM.

In one particular embodiment, the semantic classification system used for indexing the candidate query set is adapted from the lexical sense set of the WordNet project (for detailed information see http://wordnet.princeton.edu), where a semantic classification tag is denoted by a synset (synonym set). WordNet identifies a large number of semantic classes for commonly used words and denotes them with well-formed numerical tags, and further organizes these semantic classes with multiple semantic relations. WordNet has been extensively used in the research and application of information retrieval, and currently there are multilingual versions of the WordNet database (http://www.globalwordnet.org), which are used in this embodiment.

For example, the word “bank” has 17 sense identifiers (called synset_id). The occurrence times of each sense (called sense frequency sf) in a corpus used by an embodiment of the invention, together the number of documents wherein the sense occurs (called document frequency df), are listed as follows:

synset_id/sf/df

| | |
|---|---|
| “bank”: | 106227059/20/9; |
| | 106800223/14/6; |
| | 106739355/2/2; |
| | 201093881/1/1; |
| | 106250735/1/1; |
| | 201599940/0/0; |
| | 201599852/0/0; |
| | 201579642/0/1; |
| | 201393302/0/0; |
| | 200841124/0/0; |
| | 200464775/0/2; |
| | 109626760/0/0; |
| | 109616845/0/0; |
| | 106800468/0/0; |
| | 103277560/0/0; |
| | 102247680/0/0; |
| | 100109955/0/0. |

The sense space of the candidate query set is constructed with the synset ids being its dimensions. For example, if some query Q containing the word “bank”, then Q will have non-zero components in the above 17 dimensions corresponding to the synset_ids of the word “bank”. The concrete value of a component is determined by the term weighting method of the model. According to an embodiment of the invention, the conventional VSM weighting scheme of term frequency—inverse document frequency (called tf*idf weighting) is adopted to determine the component values on the sense dimensions, with the index term being the sense tags synset_ids, and thus the term frequency tf being the sense frequency sf. The similarity of any two queries Qᵢ and Qⱼ, denoted by sim(Qᵢ, Qⱼ), is measured by the cosine of the angle between their vectors on the sense space, namely,
sim(Qᵢ, Qⱼ)=cos(Qᵢ,Qⱼ). (1.)
As in conventional case, such similarity may be further adjusted by other factors like term proximity, Boolean relations, etc.

In addition, for calculating the value of formula (1), other term weighting schemes and similarity measures (such as the Probabilistic Language Model) may be adopted the same way consistent with the principles of the invention.

According to an embodiment of the invention, act 100 of FIG. 1 (namely the process of selecting multiple derived queries with a user's search query Q) may comprise the following steps:
Decomposing the query Q into small index units using the special index lexicon;
Looking up the inverted index of the candidate query set using Q's small index units to obtain a set of relevant candidate queries;
Computing the similarities of these relevant candidate queries with Q using the above formula (1), and selecting some candidate queries Q₁, Q₁, . . . , Qₙ to be the derived queries of Q, which have the largest similarity values (or have a similarity value that is larger than a given threshold).

Advantages of using the lexical senses as the fine-grained index units of the candidate query set include: retrieval of synonymous, equivalent or similar usage can be accomplished directly and efficiently; the granularity of index units can be controllable with a hierarchical sense system; indexing and retrieval of multilingual derived queries can be well supported with multilingual sense dictionaries.

Furthermore, the above process of indexing the candidate query set is performed in an off-line situation, and thus can be optimized by various commonly used inverted index optimization techniques to further improve the runtime efficiency of user query handling, which will accelerate the process of act 100.

As would be known by anyone of ordinary skill in the art, document clustering techniques based on VSM can be applied on the small documents of the candidate query set, so as to put the candidate queries of high similarity into the same group for efficient organization and retrieval of the whole candidate query set. This processing is also performed offline.

It is also obvious that the derived query set of any keyword can be constructed in advance and stored in an efficiently searchable manner, which can avoid some time-consuming retrieval processing and hence improve the runtime efficiency. Such technique is often termed query caching, as it caches the search results from the candidate query set for a query, and is especially effective for frequently searched queries. According to this embodiment, the derived queries of frequently searched keywords can be pre-constructed and stored in a lexicon as part of the information of the corresponding lexicon entries.

### Computing the Ranks of Derived Queries

After obtaining the derived queries Q₁, Q₂, . . . , Qₙ of a user's search query Q in act 100 of FIG. 1, as elaborated above, the search results of any Qᵢ of these derived queries may be individually constructed according to the conventional document retrieval processing, and then a search result list of Qᵢ is generated by sorting the results by their estimated similarities with the query Qᵢ. The number of derived queries, however, may be very large, usually around the scale of a thousand, namely n˜1000. It would take an exceedingly long time of system processing if all the search results of these derived queries are individually constructed. On the other hand, the number of queries that can be simultaneously processed by the retrieval system of a search engine is limited, depending on the parallel processing capability and scalability of the system. Thus it is usually unfeasible to construct the search results for all the selected top n derived queries Q_{1, . . . , n}. According to an embodiment consistent with the principles of the invention, each of the derived queries Q_{1, . . . , n} can be associated with a rank, and at each time of user interaction, only a few derived queries with higher ranks are selected to actually generate a search result list for each query, so as to satisfy the requirement to quickly return the results to the user.

The ranks of the derived queries Q₁, Q₂, . . . , Qₙ of a search query Q are denoted by QueryRank(Qᵢ|Q), i=1, 2, . . . , n. QueryRank(Qᵢ|Q) represents the priority degree that the system presents the derived query Qᵢ together with its search results when the user's search query is Q.

According one particular embodiment of the invention, the rank QueryRank(Qᵢ|Q) is defined to be the similarity of the queries Qᵢ and Q:
QueryRankᵢ(Qᵢ|Q)=sim(Qᵢ,Q). (2.)

According to a further embodiment of the invention, the rank QueryRank(Qᵢ|Q) is determined with an additional factor f_{History}(Qᵢ), which is the frequency of query Qᵢ in the historical search log of a search engine:
QueryRank2(Qᵢ|Q)=a·sim(Qᵢ,Q)+b·v(f_{History}(Qᵢ)), (3.)
where a and b are two adjustable parameters, representing the importance of the similarity and the search frequency respectively. The values of these two parameters can be set according to the actual effects. In one particular embodiment, the function v (f) may take a simpler linear form as follows:

$$\begin{matrix}v ( {f}_{History} ( {Q}_{i} ) ) = {f}_{History} ( {Q}_{i} ) \cdot u ( {Q}_{i} ) , & ( 4. ) \\ and & \\ u ( {Q}_{i} ) = \frac{1 + log ( tf ( {Q}_{i} ) )}{1 + log \frac{1}{n} {{å}^{n}}_{j = 1} tf ( {Q}_{j} ) } \times log \frac{N}{1 + df ( {Q}_{i} )} , & ( 5. )\end{matrix}$$

where tf (Qᵢ) and df (Qᵢ) are the term frequency (total times of occurrence) and document frequency (number of documents containing Qᵢ) in current Web document collection of the query Qᵢ, and N is the total number of documents in the collection.

According to an embodiment consistent with the principles of the invention, after obtaining the derived queries Q₁, Q₂, . . . , Qₙ of a user's search query Q, the derived queries Q_{1, . . . , n} are then ranked and sorted by the above QueryRank₁ or QueryRank₂. In the first time of user interaction, the first group of the top m<n derived queries Q′₁, Q′₂, . . . , Q′ₘ with higher ranks are selected to search the inverted index of the document collection, and a search result list is generated for each of them. In the second time of user interaction, when user chooses to look up more following derived queries, the next group of m derived queries Q′ₘ₊₁, Qₘ₊₂, . . . , Q′₂ₘ (2m≦n) are selected and processed accordingly. So on and so forth, until there are no derived queries left for lookup. In one particular embodiment, based on the system efficiency, the range of m (the number of derived queries that are selected to actually generate search results at a time) is chosen to be 5˜15, and the actual value of m can be set via the standard search engine option settings.

When the top-ranked m derived queries Q′₁, Q′₂, . . . , Q′ₘ and their corresponding search result lists are obtained, these derived queries Q′_{1, . . . ,m} may be further ranked in order to determine their importance (order of lookup) in the final search results that are to be presented to the user. From the user's point of view, such ranking is equivalent to the ranking and sorting of the m classes of search results, represented and tagged by the derived queries Q′_{1, . . . , m}.

Let ResultList(Q′ⱼ) denote the search result list (sorted by the rank of its relevant documents) of query Q′ⱼ, and DocRank(dₖ) denote the rank of document dₖ that is sorted at the kth position in the search result list. The new rank of a derived query Q′ⱼ of the user's query Q after Q′ⱼ is associated with its search result list ResultList(Q′ⱼ) is denoted by ClassRank(Q′ⱼ|Q), which represents the overall priority degree of the search result list of Q′ⱼ as a class of search results.

According to the rank of each of the documents in the search result list ResultList(Q′ⱼ), the derived query Q′ⱼ can be associated with an overall document rank, denoted by QueryDocRank(Q′ⱼ). There are at least three cases to determine the value of QueryDocRank(Q′ⱼ), as described by the following formulas:

$$\begin{matrix}{QueryDocRank}_{1} ( {Q}_{j}^{′} ) = {{å}^{N ( {Q}_{j}^{′} )}}_{k = 1} DocRank ( {d}_{k} ) , & ( 6. ) \\ {QueryDocRank}_{2} ( {Q}_{j}^{′} ) = \frac{1}{N ( {Q}_{j}^{′} )} \times {{å}^{N ( {Q}_{j}^{′} )}}_{k = 1} DocRank ( {d}_{k} ) , & ( 7. ) \\ {QueryDocRank}_{3} ( {Q}_{j}^{′} ) = {{å}^{N ( {Q}_{j}^{′} )}}_{k = 1} f ( k ) \times DocRank ( {d}_{k} ) , & ( 8. )\end{matrix}$$

where N(Q′ⱼ)=∥ResultList(Q′ⱼ)∥ denotes the number of relevant documents included in ResultList(Q′ⱼ). For very large web page collections, N(Q′ⱼ) may be some estimation or a sampling statistic, instead of the precise number of documents actually relevant to the query Q′ⱼ. In the above cases, QueryDocRank₁ is the sum of the ranks of all the documents in the search result list, representing the importance of the whole search results (as a class), namely, indicating whether such class of search results as a whole is worth presenting first to the user; QueryDocRank₂ is the arithmetic average of the ranks of all the documents in the search result list, representing the average importance of documents, or the priority to randomly browse an individual document in the result list; and QueryDocRank₃ is a weighted average of the ranks of all the documents in the search result list, where f (k) is the weighting factor. In this embodiment, f (k) may be set to

$$f ( k ) = \frac{1}{k} . \qquad ( 9. )$$

The actual form of QueryDocRank can be chosen from one of the above three forms according to the situation of application as exemplified in the following. According to an embodiment consistent with the principles of the invention, QueryDocRank₁ is chosen as a preferential ranking when the numbers of result documents of the derived queries are very different. When the document numbers in each of the result classes (represented by the derived queries) are relatively close to each other, or when they are trimmed to be so, QueryDocRank₂ and QueryDocRank₃ may be preferential. The former may be a better ranking when the differences of the document ranks in the result list are least significant, the latter may be better when the differences are somewhat more significant.

When the overall document rank of a derived query Q′ⱼ is determined by its search result list ResultList(Q′ⱼ), the rank of Q′ⱼ as a search result classification unit can be obtained by combining its rank related to the user's search query Q, i.e. QueryRank(Q′ⱼ|Q), and its overall document rank QueryDocRank(Q′ⱼ). According to an embodiment of the invention, such classification rank ClassRank(Q′ⱼ/Q) can be defined as one of the following two cases:
ClassRank₁(Q′ⱼ|Q)=QueryRank(Q′ⱼ|Q)·QueryDocRank(Q′ⱼ) (10.)
ClassRank₂(Q′ⱼ/Q)=c·QueryRank(Q′ⱼ/Q)+d·QueryDocRank(Q′j) (11.)
where c and d are tow adjustable parameters. According to this embodiment, ClassRank(Q′ⱼ/Q) may be chosen to be ClassRank₁ or ClassRank₂ according to user preferences. For example, the system may choose to rank the derived queries Q′₁, . . . , with ClassRank₁ when the user prefers looking up a small number of derived queries and their search results, and to rank Q′_{1, . . . ,m} with ClassRank₂ when the user tends to browse more derived queries and/or more of the grouped search results.

In addition, the value of ClassRank can be further adjusted according to other factors such as user click frequency, the number of pages that the user has changed, etc. Such techniques have been well known and in use in the field of conventional search result ranking, and can be directly incorporated into this component of this invention.

### Outputting and Displaying the Classified Search Results

In act 400 of FIG. 2, from the derived queries Q₁, Q₂, . . . , Qₙ of a user's query Q, the m search result lists ResultList(Q′₁), . . . , ResultList(Q′ₘ) of the m derived queries Q′₁, Q′₂, . . . , Q′ₘ with higher ranks are obtained, and Q′_{1, . . . m} may be further ranked, as elaborated above. According to an embodiment of the invention, the derived queries Q′_{1, . . . , m}, together with the L documents with higher ranks in each of the search result lists ResultList(Q′_{1, . . . , m}), are organized in a display page and presented to the user (act 500 of FIG. 2). According to the embodiment, the default value of L is set to 3, which can be reset via user option settings. The derived queries Q_{1, 2, . . . , n} are grouped into pages, each with m derived queries and their corresponding result lists. When the user selects the next group of m derived queries, namely Q′_{m+1, . . . , 2m}, the following m search result lists ResultList(Q′ₘ₊₁), . . . , ResultList(Q′₂ₘ) are constructed and presented to the user in the same way. So on and so forth, until there are no derived queries left for display.

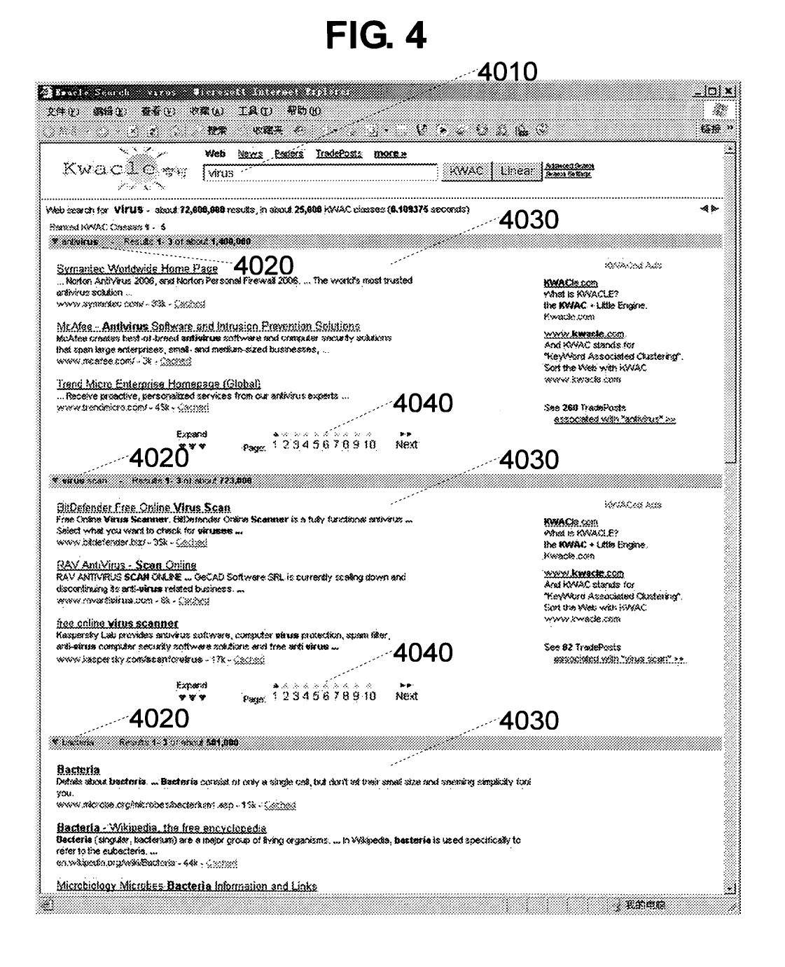

FIG. 4 is a screen shot illustrating exemplary screen display of an embodiment of the invention, where the search query input by the user is Q=“virus” 4010. The top three derived queries of Q are presented as the class names 4020 of their corresponding search results, which are
Q′₁=“antivirus”,
Q′₂=“virus scan”,
Q′3=“bacteria”.
   Q′_{1, 2, 3}, . . . are ranked and sorted according to ClassRank₁ as defined above. The representations of the top ranked 3 documents in each class are first listed.

According to this embodiment, the ranked derived queries and their search results are displayed in different subareas 4030 of the main window of the display page, with each subarea containing one derived query and its result list. Each of the subareas may be implemented as an embedded frame subwindow of the main window, such that each derived query's search result list can be independently paged down/up by the page number links 4040 for the result list. In addition, each subarea 4030 can be independently opened/closed via clicking on a hyperlink that is set up on the text of the derived query 4020 to invoke a snippet of standard HTML JavaScript code. In this way, the user may browse the classified search results of a search query Q and look up relevant results page by page only within a few interested classes.

The user may also specify the number of classes (derived queries) on each display page and the number of results listed in each class via the conventional option settings of the search engine. According to current options, the top 5 derived queries, each with 3 search results on a subarea page, are presented simultaneously on the display page.

Based on the runtime efficiency of the search engine retrieval system and the interactive mode of the Web browser software at the client end, according to an embodiment of the invention, the exemplary processing of FIG. 2 may be adjusted as follows, in order to obtain and present the search result lists of said derived queries in another way whenever appropriate (e.g. for better network load balancing or parallel processing efficiency). The adjustment comprises:
After the derived query list Q_{1, 2, . . . , n} is constructed and ranked (in act 400), the top m derived queries Q′_{1, . . . , m} with higher ranks may be immediately returned to the user-end Web browser so that the user can see these derived queries as quickly as possible, wherein each of the returned derived queries Q′_{1, . . . , m} is used to construct a “source” hyperlink of its corresponding embedded frame subwindow (namely, the URL at the “src= . . . ” attribute of the HTML <IFRAME> element);
Then the user-end browser will generate subsequent requests to the search engine for each of the returned derived queries, with the derived queries being the search queries of the subsequent requests;
The search engine processes these concurrent m derived queries, generates a search result list for each of them, and presents the top L results of each result list to the user-end browser.

As present-day mainstream Web browsers can efficiently parallelize the requests and loading of multiple hyperlink resources, in most cases the above process can be performed without introducing significant extra latency; meanwhile, the number of returned derived queries m can be effectively increased according to the parallel processing scalability of the search engine.

Additionally, in act 500 of FIG. 2, a few derived queries (e.g., 2˜3) without search results may be returned together to the user; only when the user clicks to select one of them, the corresponding search result list will be constructed, and then presented to the user as described above. In this way, the runtime efficiency of the search engine retrieval system can be further improved (whenever necessary).

### Integration with the Local Keyword Associated Clustering of Search Results

Compared to the method for search result clustering using the local “keyword associated clustering” information (herein called Local KWAC for short), as set forth in U.S. patent application Ser. No. 11/263,820 (also the China patent application Serial No. 200410091772.7 and Publication No. CN1609859A), the method of the present invention can be regarded as a global classification of search results using derived queries associated with the user query keywords (herein called “global keyword associated classification”, or Global KWAC for short). There are cases that the global KWAC method can be integrated with the local KWAC method.

For simpler search queries (e.g., queries comprising a single index term), the local KWAC method can have good quality of clustering and optimal runtime efficiency (accomplishing the clustering of all the search results in a single query processing). On the other hand, for complex search queries, the classification results presented by the derived queries of the global KWAC method can have better intelligibility, stability and accuracy than the clusters generated by local KWAC. The combination of the two may integrate their advantages and achieve even better technical effects.

According to an embodiment consistent with the principles of the invention, the global and local KWAC methods can be integrated together by adjusting the ranks of derived queries and/or clustering classes, or by merging or filtering the search results of each other. In one particular embodiment, the integration includes the following aspects:
According to the complexity of current search query, supplementing the classification or clustering results of global or local KWAC with the results of each other, to avoid missing the various possible meanings or uses of some keywords;
Filtering out some “garbage” clustering results of local KWAC with the derived queries of global KWAC;
Adjusting (re-ranking) the derived queries of global KWAC using the information of local KWAC to make them more appropriately represent the “local” weighting of the queries in individual documents.
When the number of derived queries of global KWAC is very small (e.g. below a given number), the derived query list of global KWAC and the clusters of local KWAC can be merged to present a longer list of search result classes, so that the user can have sufficient search result classes to browse and look up. The merge may be simply appending the local KWAC cluster list to the (short) list of global KWAC classes, or other union of the result groups generated by global and local KWAC.

In addition, when the system efficiency turns to be very low or limited (e.g. when there are many users submitting search requests simultaneously), a simplistic method to combine global and local KWAC can be employed, comprising:
local KWAC is used to cluster the search results of the user's query;
meanwhile, the derived query list of the user query is constructed, but without further obtaining the search results of any derived query;
the derived query list of global KWAC and the clusters of local KWAC are merged into a longer list of search result classes and presented to the user, with only the top ranked results of the local KWAC clusters being actually displayed;
postpone constructing the search results of a derived query till the user has clicked to select an (initially closed) class of the derived query in the merged list of search result classes.

### Combining the Search Results of Derived Queries

In response to a search query Q, when the list of derived queries Q_{1, 2, . . . , n} of Q is constructed and ranked, and the search result lists of the m≦n derived queries Q′_{1, . . . , m} with higher ranks are obtained, a further aspect of the second retrieval model of the present invention provides a method for integrating the search results in the multiple result lists of the derived queries Q′_{1, . . . , m}, and selecting results that may be more relevant to the user's query Q to form the final search result list (act 600 in FIG. 3). Such a technique can be used to present the search results when the user prefers a linear list view of search results (via option settings or by clicking on a special search button) while the derived query mechanism is still turned on, or when a customized search with certain derived queries is in use.

In such combination, a re-ranking mechanism is needed for appropriate selecting from the merged search results of various derived queries. Factors involved may include the document ranks of the results, the ranks and frequencies of the derived queries, etc. Let dₖ^{j} denote the kth result in the search result list ResultList(Q′ⱼ) of derived query Q′ⱼ, which is sorted by the document rank of the results. The rank value of dₖ^{j} in the result list of Q′ⱼ will be denoted by DocRank(dₖ^{j}|Q′ⱼ). The new document rank of a search result dₖ^{j} with respect to the user's query Q will be denoted by LinearDocRank(dₖ^{j}|Q).

According to an embodiment of the invention, the new rank in the combined results, LinearDocRank(dₖ^{j}|Q), is a function as follows:
LinearDocRank(dₖ^{j}|Q)=F[DocRank(dₖ^{j}|Q′ⱼ),k,tf(Q′j), df(Q′ⱼ),QueryRank(Q|Q′ⱼ),QueryDocRank(Q′ⱼ)], (12.)
where the parameters of F are defined as above. In one particular embodiment, the function F can be simplified as follows:
LinearDocRank(dₖ^{j}|Q)≈f₀(DocRank(dₖ^{j}|Q′ⱼ))·f₁(k)·f₂(tf(Q′j))·f₃(df(Q′j))·g₁(QueryRank(Q|Q′ⱼ))·g₂(QueryDocRank(Q′ⱼ))·g₀(ClassRank(Q′ⱼ|Q)), (13.)
where the functions f_{0,1,2,3} and g_{0,1,2} are defined as follows:
f₀(x)=x,f₁(x)=1/x,f₂(x)=1+log(x),f₃(x)=1/log(1+x),g₁(x)=x,g₂(x)=x,g₀(x)=constant. (14.)

The combined search result list is then obtained by ranking and sorting the search results of derived queries Q′_{1, . . . ,m} by the new document rank LinearDocRank(dₖ^{j}|Q). As usual, a specified number (typically around 1000) of the top ranked results can be grouped into pages and presented to the user.

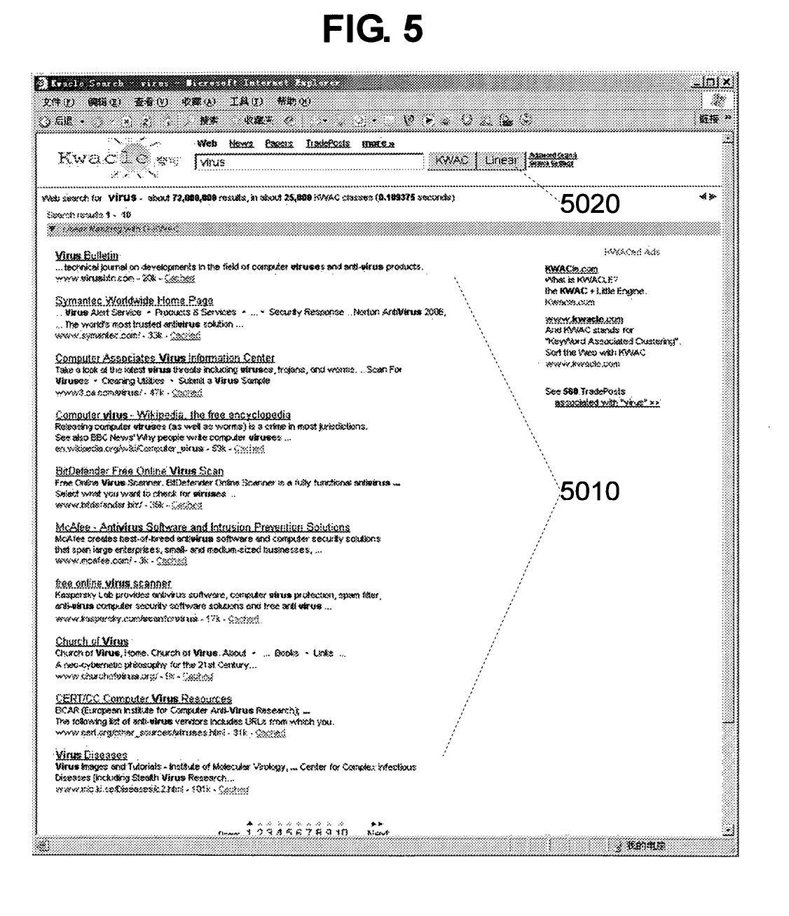

FIG. 5 is a screen shot of the display page of the linear list 5010 of the combined search results for the search query Q=“virus”, where the search results of Q's derived queries are merged and ranked by LinearDocRank(dₖ^{j}|Q) as defined above. In the embodiment, such a linear list is generated when the user inputs the search query “virus” and clicks on the “Linear” search button 5020.

In addition, for any search query Q, the linear list of search results generated with derived queries as above can be further combined with the search result list that is generated with the conventional retrieval method, which assigns a document rank DocRank(dₖ|Q) to the kth result in the list. According to this embodiment, the document rank of the mixed results is calculated as follows:
MixedDocRank(dₖ|Q)=α·LinearDocRank(dₖ|Q)+β·DocRank(dₖ|Q), (15.)
where the parameters α and β are adjusted according to system settings. Then a specified number (˜1000) of the top ranked results are grouped in pages and presented to the user as the final search results.

The above process of search result list combination is similar to the case of a metasearch engine that combines search results returned from different (independent) search engines. Many techniques for selecting and ranking search results developed in the field of metasearch (or multi-document collection retrieval) can be used for the implementation of the invention.

It would be apparent to anyone of ordinary skill in the art that aspects of the invention, as described above, may be implemented in many different forms of software and hardware in the embodiments elaborated in this specification. For example, the method of the present invention can be implemented with minor modifications in search engines that use different index structures or retrieval models. The appended claims cover variations and alterations of the embodiments consistent with the principles of the invention.

What is claimed is:

1. A method for presenting the search results in response to a search query from a search user using a computer or computer network, comprising:
a. constructing multiple derived queries for the search query; and
b. generating the search results of the search query based on at least part of the derived queries, and outputting the results to the user.

2. The method of claim 1, wherein the step (a) for constructing derived queries comprises:
a1. searching a candidate query set with the user's search query, and
a2. selecting a set of candidate queries that are relevant to the user's search query.

3. The method of claim 2, wherein said candidate query set is indexed and searched with small index units, which include short terms of words and phrases, or the senses of these words and phrases.

4. The method of claim 1, wherein each of the derived queries are associated with a rank according to a selection from the group consisting of its similarity to the search query, and its frequency in the search log.

5. The method of claim 4, wherein the rank of a derived query is further determined according to the derived query's term frequency and document frequency in current document collection.

6. The method of claim 4, wherein part of the top ranked derived queries are re-ranked according to the numbers and ranks of the documents in the corresponding search result lists of the derived queries.

7. The method of claim 1, wherein the step (b) for generation and output of the search results based on the derived queries further comprises:
b1-1. for at least part of the derived queries, constructing a search result set for each of the derived queries;
b1-2. returning at least part of the derived queries to the user; and
b1-3. at least part of the search results constructed for each of the returned derived queries are also returned to the user.

8. The method of claim 1, wherein the step (b) for generation and output of the search results based on the derived queries comprises:
b2-1. returning at least part of the derived queries to the user;
b2-2. for at least part of the returned derived queries, constructing a search result set for each of them; and
b2-3. at least part of the search results constructed for each of the returned derived queries are also returned to the user.

9. The method of claim 7, wherein the derived queries are sorted by their ranks, and derived queries with higher ranks are preferentially handled.

10. The method of claim 9, wherein the search results of each of the derived queries are sorted by their document ranks, and results with higher document ranks are preferentially presented to the search user.

11. The method of claim 10, wherein each of the returned derived queries and its search result list are presented in an independent framed subarea of the display page, and each search result list can be independently navigated using page number links.

12. The method of claim 11, wherein each framed subarea can be independently opened or closed.

13. The method of claim 8, wherein the derived queries are sorted by their ranks, and derived queries with higher ranks are preferentially handled.

14. The method of claim 13, wherein the search results of each of the derived queries are sorted by their document ranks, and results with higher document ranks are preferentially presented to the search user.

15. The method of claim 14, wherein each of the returned derived queries and its search result list are presented in an independent framed subarea of the display page, and each search result list can be independently navigated using page number links.

16. The method of claim 15, wherein each framed subarea can be independently opened or closed.

17. The method of claim 1, wherein the step (b) for generation and output of the search results based on the derived queries comprises:
b3-1. for at least part of the derived queries, constructing a search result set for each of the derived queries; and
b3-2. combining the search results of each of said derived queries to form the search results of said search query, and outputting at least part of the results to the user.

18. The method of claim 17, wherein the search results of derived queries with higher ranks are preferentially constructed.

19. The method of claim 18, wherein the documents in the merged search results of the derived queries are re-ranked according to a selection of the group consisting of original listing positions, document ranks of the results, ranks and term frequencies of the derived queries, and document frequencies of the derived queries.

20. The method of claim 19, wherein the top ranked documents in the merged search results are selected as the final results for the user's search query.
